(19) United States
(12) Patent Application Publication
(10) Pub. No.: US 2018/0280880 A1
(43) Pub. Date: Oct. 4, 2018

(54) Device for Salvaging RO Water Filter Waste Water

(71) Applicant: Tsia Yong LIM, Singapore (SG)

(72) Inventor: Tsia Yong LIM, Singapore (SG)

(21) Appl. No.: 15/570,607

(22) PCT Filed: Apr. 30, 2015
(86) PCT No.: PCT/SG2015/000124

§ 371 Date: Oct. 30, 2017

(51) Int. Cl. B01D 61/10; F03B 7/00; F04D 3/02; F04D 13/16; F04D 13/04

(52) U.S. Cl. CPC B01D 61/10; F03B 7/00; F04D 3/02; B01D 2313/246; F04D 13/04; B01D 2311/08; F04D 13/16

(57) ABSTRACT

A Device which can salvage the waste water from Reverse Osmosis Water Filter up to 100%, in others words, “Zero Waste”, without using electricity and electrical pump, and regardless of whether hot water pipeline and hot water tank are available. It channels the waste water into the cold water pipeline. This Device can be utilized in new Reverse Osmosis Water Filters and existing Reverse Osmosis Water Filter units. This Device consists of two components, a water tank and a special gadget. The special gadget is installed inside the water tank and is not exposed to external view. The water tank can be of various sizes to suit usage requirement. The Device is connected to the outlet of the said waste water outlet, the pipeline Inflow and the outflow to the faucet. The water tank is for receiving and storing the waste water and the special gadget is for salvaging and channelling the waste water to the faucet outlet, when the faucet is turned on, thereby salvaging the waste water.

### TECHNICAL FIELD

A Device designed for use in Reverse Osmosis Water filter system applying principles and theories established in the field of Physics.

### BACKGROUND

The conventional Reverse Osmosis Water filtration system (herein after named RO System) has an inherent and inevitable weak point of having high amount of waste water in the process of producing purified water. The waste water is disposed through drainage piping or floor trap.

In the market, only one brand with established Patent makes the claim of having “Zero Waste”, meaning the waste water produced in the process of filtering by the RO System is completely salvaged for usage. It achieves by utilising an electric pump, on standby mode, to pump the waste water into the hot water tank and mixed with the hot water in the tank for usage as and when the RO System is activated, thereby achieving “Zero Waste”. This is under separate existing Patent by others.

The Device for which patent rights are herewith sought for achieves the same purpose of salvaging the said waste water without utilizing electric pump and it is not channelled into the hot water tank. It channels the waste water into cold water pipeline without using electricity.

### DISCLOSURE

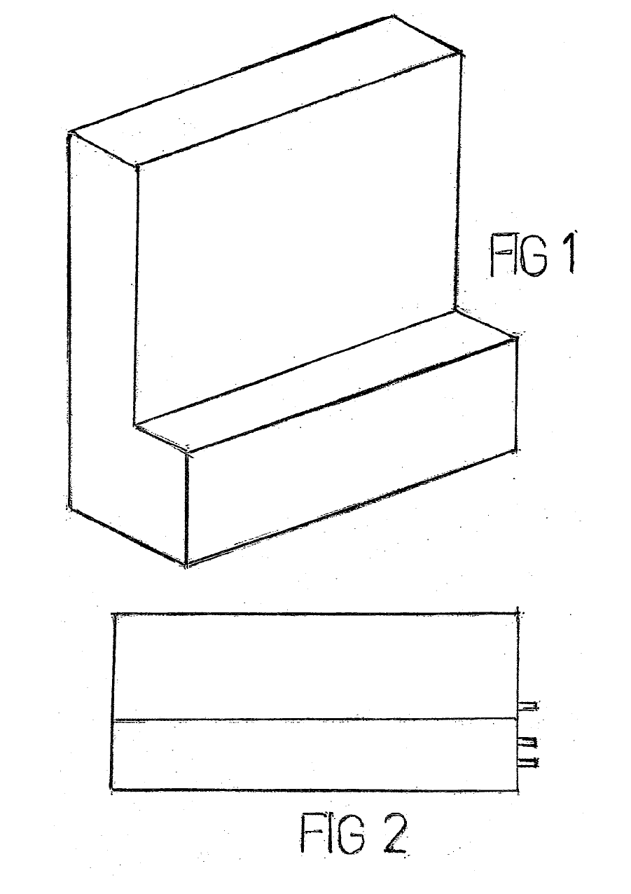

The Device consists of two components. First a Water Tank FIGS. 1, 2, 3 and 4, and second a special gadget FIG. 5. (named Gadget hereinafter) The Gadget is installed inside the Water Tank.

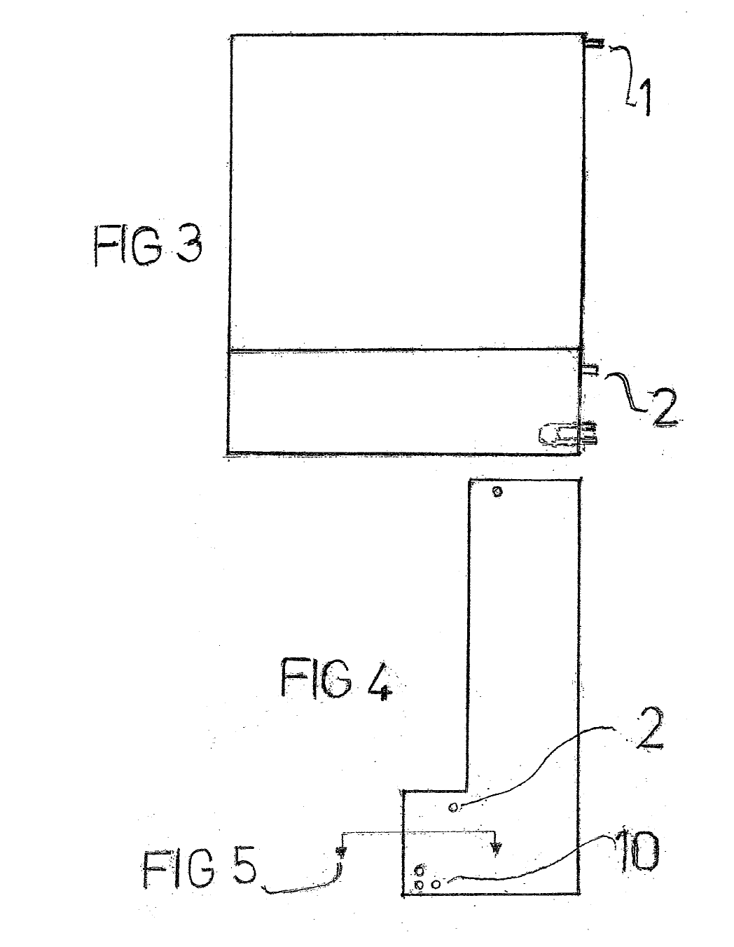

The Water Tank is incorporated into RO System by connecting to the waste water outlet of the RO System to receive and collect the waste water produced, FIG. 3 ref 2. The Water Tank is also connected to the cold water pipeline FIG. 8 ref 3 and to the faucet FIG. 8 ref 4 at the sink at Kitchen or elsewhere through the Gadget installed in the tank.

The connection to the pipeline is at point after the branch off for supply to the RO System and the flow to the Water Tank is independent from flow to RO System by way of a one-way check valve to allow flow in the direction towards the Water Tank only. The flow to RO system is controlled by the RO System itself. The flow to the Water Tank is controlled by the turning on and off of the faucet. The flow to the Water Tank is connected to the inlet of the Gadget and the outlet of the Gadget is connected to the faucet.

The dimensions of the Water Tank vary to suit three criteria.

First is space constraint. Various sizes and shapes are required for different space constraint.

The second criterion is the efficiency of the RO System. The efficiency of a RO System determines the amount of waste water produced during the filtering process. The more efficient it is, the lesser the amount of waste water, and vice versa.

An efficient RO system may need only a small Water Tank and a less efficient one would require a bigger Water Tank to ensure “Zero Waste”.

The third criterion is the pattern of usage of the user. The waste water is salvaged by the Gadget, (as explained later under this heading), and channelled into the cold water pipeline for usage when the faucet at the sink at Kitchen or elsewhere where the Device is connected to, is turned on. A user who seldom uses the said faucet for water supply, due to less cooking and washing or other usage, will need a bigger Water Tank to ensure “Zero Waste”, and vice versa.

The Water Tank is extendable. A second Water Tank may be installed by connecting to the first Water Tank by using flexible water tubing connected to the connection head provided with the Water Tank as shown in FIG. 4 ref 10, if necessary to ensure “Zero Waste”.

The waste water in the Water Tank is exposed to atmospheric pressure through an overflow outlet at the top of the Water Tank in FIG. 3 ref 1. The overflow pipe will be connected with tubing leading to drainage piping or floor trap, like in the ordinary RO System, to cater for situation where the amount of waste water produced exceed the capacity of the Water Tank. This could happen due to higher usage of purified water or lower usage of faucet water, as envisaged. The second tank for extension will not have the Gadget as it is not required. The second extension tank has an air vent outlet for upright tubing to reach the same height as that of the overflow outlet of the main tank. This air vent ensures equilibrium of the water levels in the two tanks.

The Device is designed to be incorporated into new RO System units and also existing RO System units. The Water Tank of the Device for new RO System unit is used as the supporting structure for the components of the RO System, except the pressured tank to store the purified water. The Water Tank for new RO System is in a shape with a side view the shape of a standing capital ‘L”, and rectangular front view when viewed perpendicular to the surface. The components of the RO System will either be attached to the vertical surface of the “L” or sitting on top of the base of the “L” which rest on the floor surface, FIG. 1. The Water Tank of the Device for existing RO System can be in any shape and size.

The Water Tank may be made of any materials commonly used in the water filter industry for water tank. The thicknesses of the Water Tank structure vary with the type of materials used.

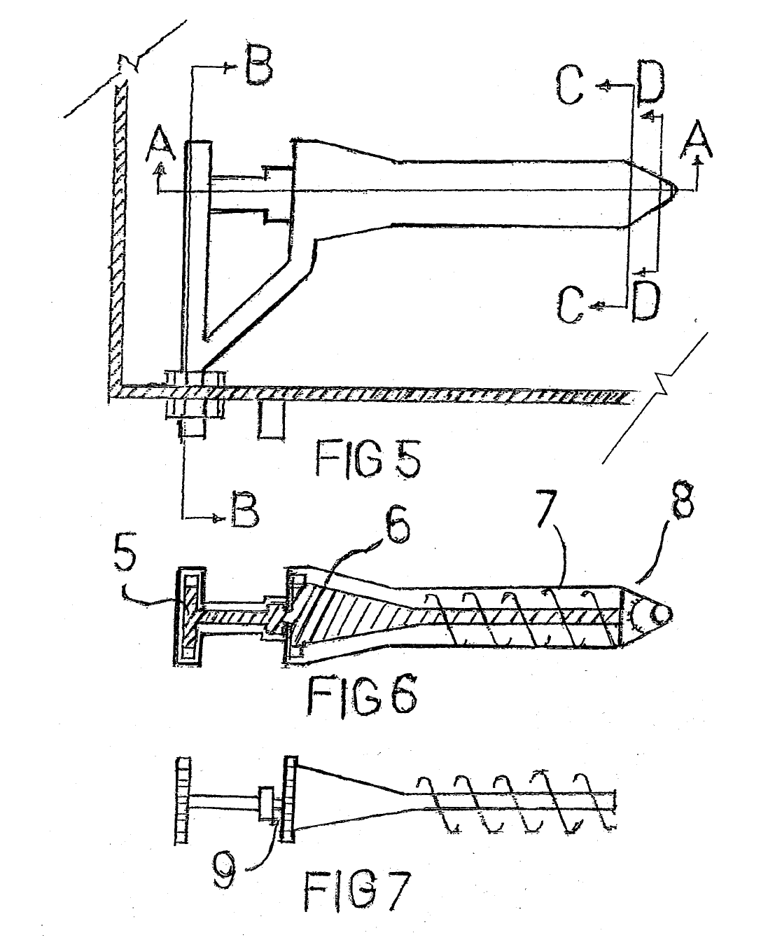

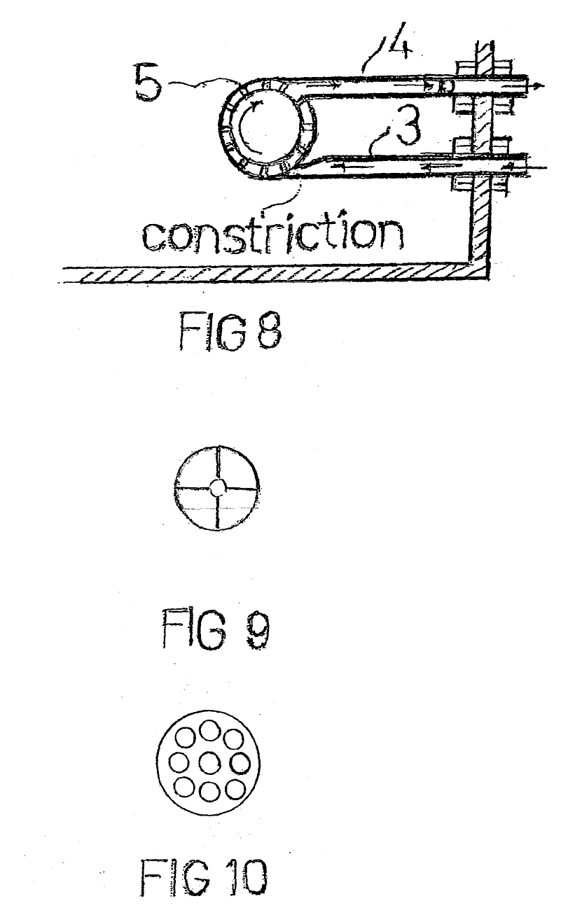

The Water Tank is equipped with a Gadget as illustrated in FIGS. 5, 6 7, 8, 9 and 10. FIG. 5 is top view of the Gadget, FIG. 6 is cross section AA, FIG. 7 is the elevation view of the Rotatable Wheels and Archimedes Screw without the casing and control section, FIG. 8 is cross section BB, FIG. 9 is cross section CC and FIG. 10 is cross section DD (exploded view) The Gadget is fixed to the vertical surface of the Water Tank internally at two points. One for inflow of pipeline water FIG. 8 ref 3 through the Gadget and one for outflow of mix of waste water and pipeline water FIG. 8 ref 4. The method of fixing can be of any conventional method which ensures water tightness and prevent leakage.

The Gadget may be classified into six distinct functional parts as described below from a) to f).

a) Inlet tubing

FIG. 8 ref 3 with parts inside and outside the Water Tank. The external part is connected to the cold water pipeline for inflow of pipeline water when faucet is turned on. The internal diameter of the tubing up to point of constriction shown in FIG. 8 is three mm or more. Beyond the point, the internal diameter is reduced to two mm or less

b) Outlet tubing

FIG. 8 ref 4 with parts inside and outside the Water Tank. The internal part is in the shape of small letter “y” on plan view. It channel and deliver the waste water from Water Tank and mix with the pipeline water at the junction of the “y” shape tubing. The internal diameter of the outlet tubing on the waste water inlet of the “y” outlet is 2.6 mm or more, the length is minimum 30 mm. The internal diameter of the part of the “y” shape outlet tubing on the pipeline water outlet side is the same as the inlet tubing after the constriction; the length is minimum 30 mm. The internal diameter of the tubing at tail end beyond the junction of the “y” shape is 3 mm or more and the length is minimum 10 mm; the external part of the outlet tubing has the same diameter and it delivers the mix of waste water and pipeline water to the faucet for usage.

c) Rotatable Wheels

There are two Rotatable Wheels FIG. 6 ref 5 and 6. The wheels are connected by a shaft which extend beyond wheel ref 6 and is also the shaft of the Archimedes Screw FIG. 6 ref 7. Wheel at ref 5 is a circular plate with 3 mm or less protrusions on the circumference of the plate. The thickness of the plate is 3 mm or less. The diameter of the plate is 25 mm or more. The protrusions are of the same size and thickness and height. The height is 3 mm or less and the thickness is the same as the thickness of the plate. The width is 1.5 mm or less. The protrusions are spaced at a minimum of 5 mm apart. Wheel at ref 6 is of same size and shape with wheel at ref 5 except it has a cone shape enlargement on one side as shown FIG. 6. The shaft has minimum diameter of 2 mm except a small part FIG. 7 ref 9 which is reduced to 1.5 mm.

d) Archimedes Screw

It is a miniature Archimedes Screw FIG. 6 ref 7. It rotates on the same shaft together with the Rotatable Wheel at same speed. The name Archimedes Screw is used as it is the preferred design. But it can be in the form of a series of miniature ship propellers sharing the same shaft for creating the required suction or driving force. The diameter of the Archimedes Screw on the extreme edge is 15 mm minimum and the length is 50 mm minimum.

e) Casing

This is the housing for the Rotatable Wheels and miniature Archimedes Screw with circular cross section. The internal diameters of the housing are bigger than the Rotatable Wheels and the Archimedes Screw at the respective parts by not more than 3 mm. The size of Casing progressively increase in size following the shape of the cone at wheel FIG. 6 ref 6 keeping a constant gap of minimum 2 mm between its internal surface and the surface of the cone shape enlargement of the shaft as shown FIG. 6.

The internal diameter of the housing between the two Rotatable Wheels for the shaft is bigger than the diameter of the shaft by not more than 0.2 mm. The end of the Casing on the Flow Control section side is covered with an element FIG. 9 for purpose of supporting the end of the shaft.

f) Flow control section

This is a cone shape section. The smaller end has a circular opening for inflow of waste water from the Water Tank. The other side of the cone is covered with an element with perforations and holes FIG. 10. (FIG. 10 is exploded view) The diameter of the base is the same as that of the Casing at the Archimedes Screw portion. Inside the Flow Control section is a free moving ball shape element. The circular opening has a minimum diameter of 2 mm. The ball shape element has a minimum diameter of 3 mm

When the Device is installed and connected as described above, the water pressure in the Gadget will be the subjected to the pipeline pressure when faucet is not turned on. As the pipeline pressure will invariably be higher than the pressure outside the Flow Control section, which is only atmospheric pressure plus water pressure of the waste water in the Water Tank, the ball shape element will be moved by the different pressures inside and outside of the Gadget and forced by the higher side, which is the inside, to move toward and plug up the circular opening once pipeline water starts to flow through the opening into the Water Tank.

When the faucet is turned on and water starts to flow at the faucet outlet, at the constriction, the speed of flow increases tremendously ( Bernoulli Theorem), which provides the driving force (Kinetic Energy) for turning the Rotatable Wheels and Archimedes Screw. The creation of the Kinetic Energy simultaneously reduces the pressure in the Gadget from point of constriction onward. (Law of Conservation of Energy)

When the Archimedes Screw starts to rotate, suction effect is created. The reduction in pressure coupled with the suction effect created, the ball shape element in the Flow Control section will be freed and moved away from the Circular opening thereby allowing the inflow of waste water From the Water Tank. The waste water will be sucked by the Archimedes Screw and be driven by wheel at FIG. 6 ref 6 into the outlet tubing. The waste water will mix with the pipeline water at the junction of the “y” shape tubing and flows towards the faucet outlet.

When the faucet is turned off, the water flow stops, which simultaneously causes the pressure in the Gadget to increase and revert back to that of pipeline pressure and as described in 10) above, the ball shape element will close the opening and stop any flow of water.

### BEST MODE OF CARRYING OUT THE INVENTION

The best is to work with established RO System manufacturers to produce the Invention.

### INDUSTRIAL APPLICATION

The RO System has been in use in the water filter industry for many decades. The disadvantage of having high wastage is a well known fact. The RO System can become very efficient water filtration system if the Invention is incorporated. The Invention therefore will be welcome and accepted by existing RO System manufacturer.

1) A Device for salvaging the waste water produced by RO Water Filter System during production of purified water, for usage; the said Device consists of a Water Tank (FIG. 1,2,3,4) with a Gadget installed internally and with an external water connection provisions; it functions without using electrical pump and or electricity; the Water Tank can be of various sizes to suit different space constraint requirements and it is for receiving and storing the waste water; the Gadget comprises of inlet tubing (FIG. 8 ref 3) to receive pipeline water, “y” shape outlet tubing to faucet (FIG. 8 ref 4), two Rotatable Wheels and a miniature Archimedes Screw sharing a same shaft for rotation (FIG. 6 ref 5,6,7) , a Flow Control section (FIG. 6 ref 8, FIG. 9,10) for starting and stopping the flow when faucet the Device is connected to is turned on and turned off, and a casing body for the Rotatable Wheels, Archimedes Screw; the Gadget is for sucking the waste water from the Water Tank and mixing it with pipeline water for usage.

2) The Device recited in claim 1) can be used for both new RO units and existing RO units.

3) The Device recited in claim 1) can salvage the said waste water up to 100% for usage.

4) The said Gadget in claim 1) does not need electrical pump or electricity to function.

5) The said Device in claim 1) does not require existence of hot water tank to function.

6) The said Gadget in claim 1) functions and stops automatically when the faucet it is connected to is turned on and turned off respectively

7) The said Water Tank in claim 1) for new RO units has a “L” shape” cross section when viewed from the sides, and a rectangular front when viewed horizontally in front. (FIG. 1, 3, 4.)

8) The said Gadget in claim 1) functions by utilizing the existing potential energy in the pressure of pipeline it is connected to.

9) The device of claim 8 wherein the gadget functions by transforming the existing potential energy into Kinetic Energy.

10) The said Gadget in claim 1) has a constriction (FIG. 8) along the pipeline inflow tubing which causes increases in speed of flow and effectively transforming the potential energy substantially into Kinetic Energy coupled with reduction of pressure in the said Gadget proportionately for portion after the constriction.

11) The said Kinetic Energy in claim 10) drives the said Rotatable Wheels and the Archimedes Screw concurrently to rotate, and the rotation creates suction power.

12) The said Gadget in claim 1) has a Flow Control section with a free moving ball shape element inside.

13) The said free moving ball shape element in claim 12) is controlled by the direction of flow in the Flow Control section, it moves in the direction of flow.

14) The said free moving ball shape element in claim 13) closes and plugs up the circular opening once the Device is connected, when the faucet is not turned on.

15) The device of claim 11 wherein a combination of the suction power created by the rotation and the reduction in pressure in the gadget free the ball shape element from the circular opening and allow inflow of waste water from the Water Tank when the faucet is turned on, the waste water is thus sucked from the Water Tank, and, assisted by one of the two rotatable wheels, is channelled to the outlet tubing which joins the pipeline water outflow at the junction of the “y” shape outlet tubing and to the faucet for usage.

16) The said Gadget in claim 1) can be in various sizes and dimensions.

17) The said Archimedes Screw in claim 11) can be replaced with a series of miniature ship propellers rotating on the same shaft.
